(19) United States
(12) Patent Application Publication
(10) Pub. No.: US 2004/0037934 A1
(43) Pub. Date: Feb. 26, 2004

(54) Method for preparing cooked rice and cooked rice prepared by the method

(75) Inventors: Teruo Kobayashi, Osaka (JP); Eiji Kawase, Osaka (JP); Kosuke Noba, Osaka (JP); Yasuko Ishizaki, Kanagawa (JP); Naoki Matsubara, Gunma (JP); Toshifumi Ando, Gunma (JP); Kazuo Takemura, Gunma (JP); Yoshinobu Fukui, Gunma (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: AJINOMOTO CO., INC., Tokyo (JP)

(21) Appl. No.: 10/644,772

(22) Filed: Aug. 21, 2003

(30) Foreign Application Priority Data
Aug. 22, 2002 (JP) 2002-242742

(51) Int. Cl. A23L 1/00

(52) U.S. Cl. 426/508

(57) ABSTRACT

A method for preparing a cooked rice with stabilized quality on an industrial scale and cooked rice prepared according to the process, which has a moisture gradient formed between the outer layer and the inner layer of each rice grain and has no hard core in the rice grains when tested organoleptically. The method includes the steps of steaming raw rice having been subjected to a washing and soaking step to effect gelatinization of starch inside rice grains; cooling and individuating the resulting rice to remove moisture present on the surface of each rice grain; frying the resulting rice with an oil to form an oil film over the surface of each rice grain; and boiling the resulting rice together with seasonings and water. In the cooked rice, difference between the moisture content of the outer layer (to the depth of 0.5 mm from the surface) and that of the inner layer (portion deeper than 0.5 mm from the surface) of each rice grain is 2.5% to 5%, preferably 3% to 5%. Further, when 10 g of the cooked rice is charged into a cylindrical container having a diameter of 25 mm and is subjected to free fall therefrom at a height of 30 cm, the diffusion area of the fallen rice is 2,500 mm² to 3,000 mm², preferably 2,700 mm² to 2,900 mm².

### TECHNICAL FIELD

The present invention relates to a method for preparing cooked rice, for example pilaf, on an industrial scale and also to cooked rice prepared according to the method.

### BACKGROUND ART

In a known method for preparing pilaf on an industrial scale, raw rice having been subjected to a washing step and a soaking step is boiled together with seasonings and an emulsifier admixed thereto. According to this method, the emulsifier imparts a dry and crumbly texture (feeling) to the resulting cooked rice. However, the cooked rice is not actually fried, so that the texture of the cooked rice is quite different from that of those subjected to frying.

Thus, there are other known methods. In one method, washed and soaked raw rice is subjected to frying and then to boiling (see, for example, Japanese Unexamined Patent Publication No. Sho 52-64439); in another method washed and soaked raw rice is subjected to steaming in a steaming step to effect gelatinization of starch contained in rice grains, followed by boiling together with an oil admixed thereto (see Japanese Unexamined Patent Publication No. Sho 52-83970).

However, in the method described in the former patent literature, the resulting cooked rice does not taste good since hard cores remain in rice grains. Besides, rice grains can hardly be coated uniformly on the surface with the oil, and they must be fried for a longer time so as to form uniform oil coating, leading to occurrence of much crumbled rice, disadvantageously. Meanwhile, in the method described in the latter patent literature, no core remains in rice grains since the raw rice is subjected to steaming, but the rice grains yet fail to be coated on the surface uniformly with the oil, disadvantageously.

It is an objective of the present invention to provide a method for preparing cooked rice with stabilized quality on an industrial scale, particularly pilaf, which has a moisture gradient formed between the surface layer and the inside of each rice grain as if it was cooked properly by a culinarian, and yet has no core when tested organoleptically, i.e., the center section of each rice grain is appropriately gelatinized, and also cooked rice prepared according to the method.

### SUMMARY OF THE INVENTION

The method for preparing cooked rice according to the present invention includes the steps of steaming raw rice having been subjected to washing and soaking to effect gelatinization of starch inside rice grains; cooling and individuating the resulting rice to remove moisture present on the surface of each rice grain; frying the resulting rice with an oil to form an oil film over the surface of each rice grain; and boiling the resulting rice together with seasonings and water.

The steps used in the method described above are explained below.

1. Steaming Step

Soaked raw rice is subjected to steaming to effect gelatinization of starch within rice grains. In this step, the rice grains do not swell, but gelatinization of starch proceeds with substantially no absorption of external moisture by the rice grains. The steaming step is suitably carried out at a steam temperature of 90° C. to 100° C. for 10 minutes to 30 minutes. It should be noted here that if soaked rice is directly fried, the rice grains readily crumble to be unable to give a product of stabilized quality. The rice which underwent the steaming step has tonicity compared with the soaked rice due to gelatinization of starch which occurred within the rice grains, so that crumbling of rice grains to be caused by physical stress scarcely occurs during the frying step.

2. Cooling and Individuating Step

If the steamed rice is directly subjected to frying, it is impossible to form an oil film uniformly over the surface of each rice grain, due to the moisture present on the surface of the rice grain and due to the moisture migrated from the inside of each rice grain to the surface thereof, and further the rice grains are bound with each other to form clumps. Thus, the steamed rice cannot be fried uniformly and evenly. Therefore, the cooling and individuating step is incorporated here as a pretreatment for the frying step so as to remove moisture present on the surface of each rice grain. Methods for removing moisture on the surfaces of rice grains are not limited particularly. However, in order to carry out securely this treatment stably on an industrial scale and in a short time, there is preferably employed forced aeration. More specifically, a blower is positioned below a belt conveyor, and air at ambient temperature is blown from the blower up against the steamed rice carried on a mesh-like conveyor belt while the rice is spread evenly over it by unbinding clumps with a swizzle stick having comb-like fingers.

3. Frying Step

The rice having been subjected to the cooling and individuating step is fried in a tumbling barrel (bottomed cylinder) of a batch frying machine. Preferably, the rice is charged into a barrel type continuous frying machine and is fried therein. The continuous frying machine is capable of frying rice continuously. The frying step incorporated before the boiling step accelerates gelatinization of starch present in the surface layer of each rice grain to prevent the moisture inside the grain from escaping to the outside. The frying step also accelerates drying of the surface of each rice grain with heat to securely remove the moisture present on the surface of the rice grain which failed to be removed in the cooling and individuating step and remains there. Thus, there occurs substitution of water on the surface of the rice grain with an oil to form uniform oil coating over the surface of each rice grain, improving a dry and crumbly feeling of the rice grains to inhibit absorption of water by them during boiling. In the conventional methods, for example, the one disclosed in the latter patent literature incorporated herein as reference, there occurs no substitution of water with oil, so that the surface of the rice grain cannot be coated uniformly with the oil. Further, in the conventional methods, there also occur heat denaturation on the surface of the rice grain and physical disintegration of the texture, and they are also causations of inhibiting water absorption by the rice grains during boiling. This inhibition of water absorption forms moisture gradient between the surface layer and the inside of each rice grain. The rice is fried preferably at a temperature of 200° C. to 230° C. for about 3 minutes.

4. Boiling Step

The fried rice is charged into a boiling vessel of a rice cooker and the like and is boiled together with water, suitable seasonings and other ingredients added thereto. In this step, the method of cooking the fried rice is not particularly limited, and the fried rice may be cooked according to the ordinary boiling method using a rice cooker or according to the steam cooking method.

Meanwhile, in the cooked rice prepared according to the cooking method of the present invention, the difference between the moisture content of the outer layer (to the depth of 0.5 mm from the surface) and that of the inner layer (portion deeper than 0.5 mm from the surface) of each rice grain is 2.5% to 5%, preferably 3% to 5%. Further, when 10 g of the cooked rice is charged into a cylindrical container having a diameter of 25 mm and is subjected to free fall therefrom at a height of 30 cm, the diffusion area of the fallen rice is 2,500 mm² to 3,000 mm², preferably 2,700 mm² to 2,900 mm ²

According to the method of the present invention, pilaf with no hard core can be prepared by virtue of the steaming step incorporated. Further, the cooling and individuating step achieves uniform coating of the rice grains with an oil to prevent them from clumping and gives pilaf of individuated rice grains. Particularly, since the rice grains having been subjected to the cooling and individuating step are fried with an oil, the surface of each rice grain is coated uniformly with the oil which inhibits water absorption in the subsequent boiling step to form the moisture gradient between the outer layer and the inner layer of the rice grain.

Meanwhile, it is possible to obtain pilaf with no hard core in rice grains according to the conventional method incorporated with the steaming step. However, the method is devoid of a cooling and individuating step and the frying step, so that the rice grains fail to be coated uniformly with an oil to make moisture penetrate much more into the rice grains during the boiling step. The resulting pilaf has a poor texture, since the entire rice grain has a uniform moisture content. Further, pilaf cooked properly by a culinarian has a stiff portion (core) at the center of each rice grain and is unacceptable to those who prefer soft and full texture. However, the present invention has made it possible to give pilaf which has no hard core in each rice grain but has a soft and full texture. More specifically, the method of the present invention is able to provide pilaf having the desired texture like that of one cooked properly by a culinarian and yet is devoid of the rather undesired hard texture remaining in cores.

Further, the steaming step incorporated before the frying step in the present invention can stabilize product quality (inhibit occurrence of crumbled rice) and achieve gelatinization of the inner portions of rice grains to give soft and full texture. Further, the cooling and individuating step incorporated after the steaming step prevents clumping of steamed rice grains to enable uniform frying treatment. In the frying step, an oil film is formed adequately around each rice grain to reduce stickiness and adhesive property and give dry and crumbly feeling. Thus, the method of the present invention can be applied not only to preparation of pilaf but also to preparation of any type of cooked rice. As described above, the method of the present invention enjoys an advantage that it has a wide range of applications.

### MODE FOR CARRYING OUT THE INVENTION

### EXAMPLE

Preparation Method of Sample

The preparation method of the present invention will be described below by way of a preferred embodiment. The steps used in comparative examples and so on were performed in the same manner as in this embodiment.

(1) Washing Step

Clean raw rice (1.5 kg) was washed with flowing water by conventional procedure.

(2) Soaking Step

The washed rice was soaked in water at ambient temperature (20° C.) for 60 minutes.

(3) Steaming Step

The soaked rice was drained and steamed for 15 minutes in a 300 mm-diameter steamer basket for domestic use.

(4) Cooling and Individuating Step

The steamed rice was left to stand at room temperature for 5 minutes and was cooled to 30° C. to 40° C. while unbinding clumps.

(5) Frying Step

The cooled rice was charged into a revolving frying machine (RCD-1; KUMANO CHUBO) heated to 230° C. together with 30 g of salad oil and fried therein for 3 minutes.

(6) Boiling Step

The fried rice was transferred into a rice cooker (RR-10VF, Rinnai Corporation) and was boiled together with 2 kg of water added thereto.

Preparation methods of the samples are as shown in Table 1.

TABLE 1

| Sample | Step |
|---|---|
| (1) Present | Washing → Soaking → Steaming → Cooling anf |
| embodiment | Individuating → Frying → Boiling |
| (2) Culinarian | Raw rice → Frying → Boiling |
| method | |
| (3) Convention | Washing → Soaking → Steaming → Admixing oil → |
| method | Boiling |
| (4) Comp. Ex. A | Washing → Soaking (20° C., 30 min.) → Frying → |
| | Boiling |
| (5) Comp. Ex. B | Washing → Soaking (20° C., 60 min) → Frying → |
| | Boiling |
| (6) Comp. Ex. C | Washing → Soaking (90° C., 100 sec.) → Frying → |
| | Boiling |
| (7) Comp. Ex. D | Washing → Soaking → Frying (230° C., 30 sec.) → |
| | Boiling |
| (8) Comp. Ex. E | Washing → Soaking → Frying (230° C., 1 min.) → |
| | Boiling |
| (9) Comp. Ex. F | Wahing → Soaking → Frying (230° C., 2 min.) → |
| | Boiling |

Properties of the pilaf samples obtained according to the methods (1) to (9) respectively have been analyzed.

Analytical Method

A. Moisture Content in the Outer Layer and Inner Layer of Rice Grain

From a cooked rice grain were cut out an outer layer to the depth of 0.5 mm from the surface of the grain and an inner layer of the depth of more than 0.5 mm from the surface with a microtome. Moisture content of the thus obtained outer layer and that of the inner layer were calculated by means of a dry loss measurement method (ambient pressure, 105° C., 4 hours).

B. Dry and Crumbly Feeling of Cooked Rice

The dry and crumbly feeling was determined as follows: Each pilaf sample obtained by the individual cooking method was left to stand for 10 minutes, and then 10 g of specimen was extracted therefrom. The specimen was charged into a 25 mm-diameter cylindrical vessel and then subjected to free fall therefrom at a height of 30 cm. The state of fallen rice grains were photographed with a digital camera. The diffusion area of the fallen rice grains was calculated using a multipurpose image processing software (S2K-PRO, NanoHunter). The higher the dry and crumbly feeling is, the broader is the diffusion area. This measurement was carried out 10 times per specimen, and a mean value was calculated.

Result of Analysis

In order to examine the influence of difference between the moisture content of the inner layer and that of the outer layer on sense, various types of cooked rice samples were prepared (preparation methods are as shown in (1) to (6) of Table 1). Eating quality of each sample was evaluated (sensory test) by means of preference of texture, and the results of test are shown in Table 2 together with the moisture content of the inner layer and that of the outer layer, as well as, difference between them. The sensory test was performed by 10 taste panelists, who evaluated the samples by a 5-step rating method under the following criteria: − (not preferable) to +++ (very preferable).

TABLE 2

| | Present | Culinarian | Conventional | Comp. | Comp. | Comp. |
|---|---|---|---|---|---|---|
| | embodiment | method | method | Ex. A | Ex. B | Ex. C |
| Outer layer (%) | 63.0 | 55.0 | 59.5 | 55.0 | 55.5 | 55.0 |
| Inner layer (%) | 60.0 | 50.0 | 58.9 | 52.1 | 53.0 | 53.3 |
| Difference in | 3.0 | 5.0 | 0.6 | 2.9 | 2.5 | 1.7 |
| moisture | | | | | | |
| content (%) | | | | | | |
| Sensory test | +++ | ++ | ± | ++ | + | ± |
| (mean) | | | | | | |

As shown in Table 2, preferable texture was obtained in the samples when the difference between the moisture content of the inner layer and that of the outer layer was between 2.5% and 5%. Particularly, those samples having the difference of between 3% and 5% were rated higher.

In order to examine correlation between the dry and crumbly texture (feeling) and the sensory test, various kinds of samples were prepared (according to the methods shown in (1) to (3) and (7) to (9) of Table 1). The results of the analysis are shown in Table 3. The sensory test with respect to the dry and crumbly texture (feeling) was performed by 8 taste panelists, who evaluated the samples by a 5-step rating method under the following criteria: − (not preferable) to +++ (very preferable).

TABLE 3

| | Present | Culinarian | Conventional | Comp. | Comp. | Comp. |
|---|---|---|---|---|---|---|
| | embodiment | method | method | Ex. D | Ex. E | Ex. F |
| Diffusion | 2718 | 2924 | 1779 | 1977 | 2022 | 2532 |
| area of fallen | | | | | | |
| rice grains | | | | | | |
| (mm²) | | | | | | |
| Sensory test | ++ | +++ | ± | ± | ± | + |
| (mean) | | | | | | |

As shown in Table 3, the samples which gave preferable dry and crumbly texture (feeling) showed a diffusion area of about 2,500 mm² to 3,000 mm². Particularly, those rice samples having shown a diffusion area of 2,700 mm² to 2,900 mm were found to be rated higher.

What is claimed is:

1. A method for preparing cooked rice; the method comprising the steps of:
steaming raw rice having been subjected to a washing and soaking step to effect gelatinization of starch inside rice grains;
cooling and individuating the resulting rice to remove moisture present on the surface of each rice grain;
frying the resulting rice with an oil to form an oil film over the surface of each rice grain; and
boiling the resulting rice together with seasonings and water.

2. A cooked rice prepared according to the method as set forth in claim 1, wherein boiled rice grains have an outer layer to the depth of 0.5 mm from the surface of the grain and an inner layer deeper than 0.5 mm from the surface; the outer layer and the inner layer have a moisture content difference of 2.5% to 5% between them.

3. The cooked rice according to claim 2, wherein the cooked rice shows a diffusion area of 2,500 mm² to 3,000 mm², when 10 g of the cooked rice is charged into a cylindrical container having a diameter of 25 mm and is subjected to free fall therefrom at a height of 30 cm.
